(19) United States
(12) Patent Application Publication
(10) Pub. No.: US 2026/0203355 A1
(43) Pub. Date: Jul. 16, 2026

(54) EFFICIENT GENERATION OF ZONAL SUMMARIES OF GEOSPATIAL DATA

(71) Applicant: Indigo Ag, Inc., Charlestown, MA (US)

(72) Inventors: Michael J. SALIB, Cambridge, MA (US); Tina A. CORMIER, Brunswick, ME (US); Bobby H. BRASWELL, Portsmouth, NH (US)

(21) Appl. No.: 19/136,232

(22) PCT Filed: Dec. 20, 2023
(86) PCT No.: PCT/US2023/085208

§ 371 Date: Jun. 5, 2025

Related U.S. Application Data
(60) Provisional application No. 63/476,270, filed on Dec. 20, 2022.
(60) Provisional application No. 63/526,321, filed on Jul. 12, 2023.

(51) Int. Cl. G06F 16/909; G06F 16/29; G06T 7/11

(52) U.S. Cl. CPC G06F 16/909; G06F 16/29; G06T 7/11

(57) ABSTRACT

The method includes a first node receiving an input shape representing a field boundary with geographic coordinates. The first node accesses a geospatial data raster which includes tiles and with metadata defining boundaries of the tiles. The input shape is partitioned into multiple request shapes based on the boundaries of the tiles and the input shape's coordinates. The first node generates a first request to a second node to produce a zonal summary for the input shape. The second node generates a second request in response to receiving the first request, to generate a request shape digest for each of the plurality of request shapes. The second node instantiates workers to perform the second request. The workers generate digests based on tiles overlapping the request shape, and provides the digests to the first computing node, which aggregates the digests to produce a zonal summary for the input shape.

### CROSS-REFERENCE TO RELATED APPLICATIONS

This application claims priority to U.S. Patent Application No. 63/476,270, titled “Efficient Generation of Zonal Summaries of Geospatial Data,” filed on Dec. 20, 2022, and U.S. Patent Application No. 63/526,321, titled “Efficient Generation of Zonal Summaries of Geospatial Data,” filed on Jul. 12, 2023; the disclosure of which is hereby incorporated by reference in its entirety.

### BACKGROUND

Embodiments of the present disclosure relate to analysis and visualization of geospatial data, and more specifically, to efficient generation of zonal summaries of geospatial data.

### BRIEF SUMMARY

According to embodiments of the present disclosure, methods of and computer program products for generation of zonal summaries of geospatial data are provided.

Zonal summaries of a geographic area can be efficiently generated by distributing computing tasks to ensure optimal utilization of resources. The method includes a first computing node receiving an input shape representing a field boundary with geographic coordinates. The first computing node accesses a geospatial data raster with metadata defining its boundaries. The input shape is partitioned into multiple request shapes based on the geospatial boundaries of the raster and the input shape's coordinates. The first computing node generates a first request to a second computing node to produce a zonal summary for the input shape, specifying the geospatial data raster and request shapes. The second computing node generates a second request in response to receiving the first request, the second request to generate a request shape digest for each of the plurality of request shapes. The second computing node instantiates workers to perform the second request. The workers generate digests based on overlapping tiles of the geospatial data raster. Upon completion, the first computing node aggregates the digests, producing a zonal summary for the input shape. In some embodiments, the first computing node communicates with more than one second computing node to perform the first request and generate zonal summaries for input shapes. This method enhances the processing of geospatial data by efficiently utilizing distributed computing resources.

In some aspects, the techniques described herein relate to a method, wherein the input shape is partitioned into the plurality of request shapes representing the input shape based on a maximum execution time.

In some aspects, the techniques described herein relate to a method, wherein each instantiated worker generates a request shape digest for a same number of request shapes.

In some aspects, the techniques described herein relate to a method, wherein a number of workers instantiated on the one or more second computing nodes corresponds to a number of request shapes.

In some aspects, the techniques described herein relate to a method, wherein a number of workers instantiated on the one or more second computing nodes is determined by a cost-based analysis based on an availability of resources of the one or more second computing nodes.

In some aspects, the techniques described herein relate to a method, wherein generating the first request includes grouping the request shapes into one or more requests based on proximity of the geographic coordinates of the request shapes.

In some aspects, the techniques described herein relate to a method, wherein grouping the request shapes includes constructing a graph among the request shapes and identifying strongly connected components by applying Kosaraju's algorithm.

In some aspects, the techniques described herein relate to a method, wherein the first request further includes a date and wherein the worker retrieves the plurality of tiles based on the date.

In some aspects, the techniques described herein relate to a method, further including: selecting each of the one or more second computing nodes, by the first computing node, based on locality between each of the one or more second computing nodes and the plurality of tiles of the one or more geospatial data raster.

The system may include a client device, one or more databases, and a serverless component, all communicatively coupled to a network. In an embodiment, the client device includes the first computing node, and the serverless component includes one or more second computing nodes. The one or more databases store the remote sensing data and field data. The first computing node and the second computing node communicate over the network to generate zonal summaries for input shapes according to the method described above. In some embodiments, the system includes more than one second computing node.

In various embodiments, a computer program product for dynamic data tiling is provided, the computer program product comprising a computer readable storage medium having program instructions embodied therewith, the program instructions executable by a processor to cause the processor to perform a method including: reading, at a first computing node, one or more input shape having geographic coordinates; reading, at the first computing node, metadata of one or more geospatial data raster, the one or more geospatial data raster comprising a plurality of tiles, the metadata defining boundaries of the plurality of tiles; splitting the one or more input shape into a plurality of request shapes along the boundaries of the plurality of tiles, based on their geographic coordinates; constructing, at a first computing node, a request for one or more zonal summary and/or field chip, the request identifying the plurality of request shapes and the one or more geospatial data raster; sending the request from the first computing node to a second computing node; receiving the request by the second computing node; instantiating a worker at the second computing node; retrieving, by the worker, a plurality of tiles of the one or more geospatial data raster, each overlapping one of the plurality of request shapes; generating, by the worker, a digest and/or a field chip fragment corresponding to each of the plurality of request shapes based on its overlapping tile; sending the digest and/or field chip fragment corresponding to each of the plurality of request shapes from the second computing node to the first computing node; receiving, by the first computing node, the digest and/or field chip fragment corresponding to each of the plurality of request shapes; and combining, by the first computing node, the digest and/or field chip fragment corresponding to each of the plurality of request shapes into a zonal summary and/or field chip. In some embodiments, the first computing node communicates with more than one second computing node to perform the first request and generate zonal summaries for input shapes.

### BRIEF DESCRIPTION OF THE DRAWINGS

FIG. 1 illustrates a method of generating a zonal summary according to embodiments of the present disclosure.

FIG. 2 illustrates an exemplary computational framework integrating zonal summaries into an overall pipeline to deliver comprehensive insights according to embodiments of the present disclosure.

FIG. 3 illustrates a service for generating zonal summaries according to embodiments of the present disclosure.

FIGS. 4A-C illustrate exemplary boundaries crossing multiple tiles according to embodiments of the present disclosure.

FIG. 5 illustrates an exemplary method for generating zonal summaries of geospatial data, according to embodiments of the present disclosure.

FIG. 6 depicts a computing node according to embodiments of the present disclosure.

FIG. 7 illustrates an example system environment, according to according to embodiments of the present disclosure.

FIG. 8 is a flowchart illustrating an example method for generating a zonal summary for an input shape, according to embodiments of the present disclosure.

### DETAILED DESCRIPTION

The current state of the art in agricultural remote sensing presents a powerful medium to capture and analyze comprehensive field data, enhancing agricultural decision-making on multiple fronts. Diverse pouches of relevant data including crop health, soil properties, moisture levels, and growth patterns are made available through a combination of sophisticated sensors and satellites constantly surveilling and recording change.

Notwithstanding the potential latent benefits in this wealth of information, it remains a challenging task to unlock and use all these data points effectively, both due to the sheer volume and multi-dimensional nature of the data, and complexities inherent in accurate interpretation.

In this vast space, the accurate determination of field boundaries from remote sensing data has seen incremental improvements, transforming from a largely manual, time-consuming task to a more automated yet imperfect process. Sophisticated algorithms, incorporating machine learning, have proven able to delineate crop field boundaries with increasing accuracy. Nevertheless, these algorithms often struggle to perfectly replicate on-ground realities due to complexities including overlapping growing seasons, inter-crops, mixed cropping patterns, and dynamic topographical changes.

Arguably one of the most enduring challenges is the precise alignment of field boundaries with the collected remote sensing data (e.g., assigning data obtained from a satellite to a particular field based on its field boundary). Despite innovations, this alignment continues to be problematic due to factors such as the inherent spatial and temporal resolution limitations of remote sensing technology, time lag between data capture and analysis, and changes in field boundaries across agricultural cycles. This extends beyond a mere issue of data accuracy, affecting the capability to use remote sensing data in a way that is predictive, actionable, and directly linked to the ground reality.

Expanding on these critical challenges, the processing of the immense cache of multidimensional remote sensing data overlaid with dynamic field boundaries poses a set of unique predicaments. The breadth and depth of this data dwarf typical data sets, leading to an escalating need for superior computational power and innovative data handling methodologies. Traditional data processing methods, designed for smaller, simpler datasets, falter in the face of such extensive data volumes.

Many of these issues arise from varying data sources each with their peculiar quirks, divergent data forms that need to be reconciled and harmonized, and different qualities of data that may influence the final analysis. Moreover, ensuring real-time, or near real-time, data access is often critical for meaningful and timely decision-making in agriculture. The inability to process and access these datasets quickly can render even the most insightful data useless, falling short of the requisite speed of response characteristic of agricultural challenges.

However, adopting a more strategic approach to data processing, such as partitioning the data into smaller, digestible “chunks”, can dramatically improve the overall efficiency of the data modeling process. This partitioning methodology is not merely a means of breaking down data for ease of management; it has significant implications for how we view and interact with data. Each partition can be processed separately, and in parallel, thereby accelerating the overall handling of data and reducing the demand for high-powered computing resources.

Needless to say, this approach also enhances the granularity of data analysis, enabling a finer examination of data at a more localized level. Consequently, any models using granular data processed as partition can be more accurate and insightful since they are of higher fidelity-essentially ‘zooming in’ on the finer details that would otherwise may have been overlooked. By partitioning the data into smaller segments, the weight of this voluminous data becomes manageable, and agricultural models can operate more efficiently, ultimately leading to higher-quality decision-making in agriculture.

This application, therefore, presents an innovative solution that addresses these issues head-on. It provides a more robust method for field boundary determination and alignment of remote sensing data, as well as an efficient way to process and partition the data, thereby enhancing the efficiency of the resulting agricultural models.

The present disclosure provides architectures for making zonal summaries and field chips from remote sensing data and field boundaries using a partition process that increases the efficiency of processing the vast amount of data. In various embodiments, it is run locally, distributed among multiple cloud services, or executed by multiple workers on a cloud service.

Remote sensing data is fundamentally oriented around rasters-large grids of pixels. However, dealing with large rasters poses several challenges. Most single-use cases don't need access to a trillion pixels at a time, they only need the pixels for a particular county, state, or field. Accordingly, a subset of a large dataset is taken. However, those subsets are frequently not a consistent size. Because of cloud cover, there is a different number of pixels for the same county every day. Many remote sensing sources produce rasters on unpredictable cadences (amplified by cloud cover), so not even every day.

To provide data suitable for analysis, it is desirable to transform from raster data to columnar data. A zonal summary fills this need, and an exemplary embodiment is described below.

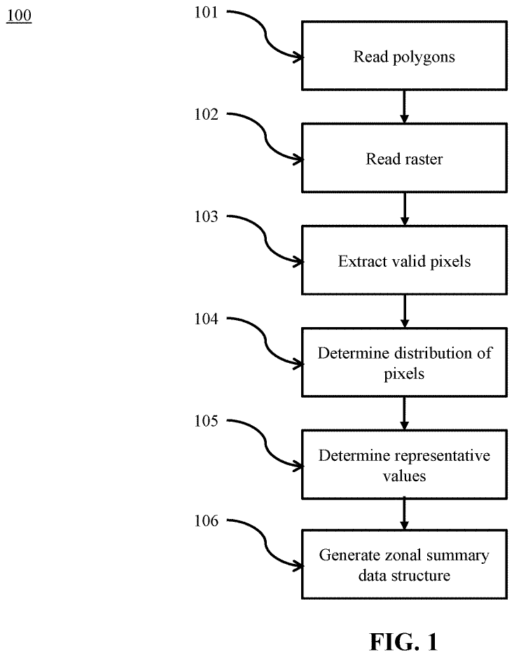

Referring to FIG. 1, a method of generating a zonal summary is illustrated. At 101, a set of polygons is read. The set of polygons may be, e.g., countries, states, countries, fields, zip codes, etc.). At 102, a raster product is read. The raster product may be any of a variety of raster remote sensing products as described herein. At 103, a set of valid pixels is extracted for each day in a period of interest (or some other division of a period of interest). A valid pixel is, e.g., one that is not covered by clouds. At 104, the distribution of pixel values for each polygon is determined. At 105, the distribution is reduced to a set of representative values, e.g., minimum, maximum, mean, etc. At 106, a zonal summary for each polygon is generated.

A zonal summary is a table or other data structure representing each polygon and comprising data associated with that polygon. In an exemplary table, a zonal summary is represented by a set of rows, where each row represents one-time division of a period of interest. Each row has columns representing different information for that time division. For instance, each row has columns for the id of the polygon, the date (or date and time) of the observation, the number of valid pixels in that observation, and the summary statistics (min/max/mean/etc.) Zonal summaries make remote sensing data legible for machine learning, business analytics, and simple visualization. Along the way, a zonal summary may reduce the data consumers need to process by a factor of 1,000,000, and, as such, the generation of a zonal summary within a system environment enables more efficient use of systems and components within that environment.

In addition to a zonal summary, the method of FIG. 1 may also generate field chips for visualization and analysis purposes. A field chip is a small chunk of imagery, produced for every date requested for every polygon and for every band (e.g., spectral band in the image). In an embodiment, a zonal summary may include both information associated with a zone and a visual representation of the information of the zone (e.g., field chip). In some embodiments, these chips are written to a cloud storage such as RNS in an image format such as TIFF. These files contain only the pixels that fit in the subject polygon; all other pixels are set to no_data. Field chips are useful to show users images of their fields or to build machine learning models that, for example, benefit from image textures.

Many raster data products that may be used in generating zonal summaries are organized into tiles (for example, HLS is a series of 110 km diamonds). A polygon may span one or more tiles. For zonal summaries, systems according to the present disclosure will summarize each tile and stitch the results together. For field chips, some embodiments provide a set of chips from different tiles for a requestor to stitch together, while some embodiments provide a pre-stitched composite.

It will be appreciated that a variety of image corrections may be applied prior to the provision of a field chip, or by the requester after receiving a field chip. A common use case for field chips is building RGB images for human consumption. However, most satellite imaging sensors measure reflectance, and those images may be additionally processed such that their information is presentable to a user. In particular, red, green, and blue bands must be combined into an RGB image. Moreover, gamma correction is applied because a user's rendering pipeline generally applies an inverse gamma correction with the expectation that all camera-produced images have already been gamma corrected. Failure to make the appropriate correction may yield a dark image that is unsuitable for presenting information in field chips. It may be desirable to adjust image saturation as well.

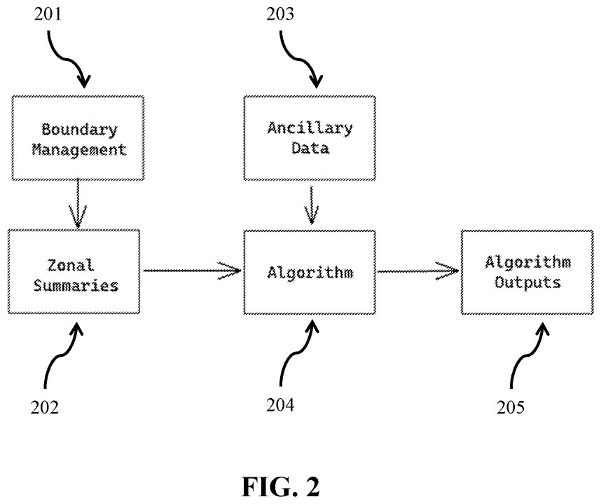

Referring to FIG. 2, an exemplary computational framework is illustrated that demonstrates how zonal summaries integrate into an overall pipeline to deliver comprehensive insights. Briefly, field boundaries 201 are employed to generate relevant zonal summaries 202. The zonal summaries are combined with any ancillary data 203 for the performance of algorithms 204 (such as machine learning models) to generate outputs 205 for consumption by users or additional systems.

Two types of data are generally required for remote sensing algorithms 204—field boundaries and gridded time series of remote sensing and weather data. Field boundary data are derived from manually delineated fields (e.g., a user indicates a field boundary) or automatically generated (e.g., using computer-vision machine learning algorithms), and in some embodiments are stored on a remote network system database (e.g., Amazon Web Services RNS, hereinafter “RNS”) as shapefiles. Depending on the data set and algorithm, gridded satellite and weather time series may either be downloaded and archived on RNS resources on a fixed schedule or accessed through public RNS databases on demand.

Field boundary data and attributes collected for each field are critical to the performance of the models described above. These data are stored in a series database table and are subjected to an automated quality control process. Boundaries are ingested, processed in batches with assigned time stamps (to account for new boundaries arriving in the system), and then stored on RNS databases.

The models generate insights based on features derived from time series of remote sensing and weather observations. These data are derived from diverse sources with different formats. Hence, the data ingestion process accounts for and records the provenance of each granule of data. To this end, the source of every data asset used in each algorithm is logged to a provenance tracker.

Ingestion of these data sources follows one of two distinct pathways. The first pathway is for coarse spatial and temporal resolution data sets hosted in a private remote database (e.g., university or federal data archives outside of the commercial cloud). The second pathway is for higher spatial/temporal resolution data sets that are available through publicly accessible remote databases. The publicly accessible remote databases enable object storage and are generally provided by commercial cloud vendors (e.g., AWS, Azure, Google Cloud Platform). For the first pathway, which includes CDL, PRISM, and SMAP, the data may be downloaded and archived in RNS databases on a scheduled cadence. As part of this process, the data are ingested and converted from their native format into geoTIFFs, which is the common format used for all gridded (including remote sensing) data. The second pathway is used for HLS and Landsat7, which are available from AWS (https://registry.opendata.aws/) or from Microsoft's Planetary Computer (https://planetarycomputer.microsoft.com). These data assets are downloaded and processed on demand and as needed by the remote sensing algorithms. For both pathways, any time a new data set is downloaded or processed, the provenance of the data set is recorded.

The remote sensing algorithms use data that have been summarized for each field boundary. This process (called zonal summary) converts time series data from many thousands of individual granules (individual raster files) into a single DataFrame that is stored as a text file on RNS, where each row is a single time series observation for a single boundary polygon record. The resulting data set consists of a time series of zonal summaries for each input feature (remotely sensed measurement, weather variable) for each field.

Model implementation involves training the algorithms (estimating a model) and then using the trained models to predict each quantity of interest for all fields. The zonal summary inputs are extracted and stored as text files. Model training and prediction follow the same steps: ingest the raw time series data, generate features from these data, insert the features into a model, and format store the results. The estimated models are stored as binary files on an RNS. The model prediction uses the trained model in combination with extracted features for each field to generate the predicted state for each quantity of interest, which are stored on RNS as text files.

Available field data (e.g., field boundaries with labeled attributes for each variable of interest) are split into training and testing subsets. The model training step is performed once using field-scale features based on zonal summaries and generates a model that predicts a specific value for each field based on model-specific input features. The model testing step uses cross-validation methods specific to each algorithm and requires zonal summary data for all fields in the test set. Models are estimated and stored for individual Crop Management Zone or global models, depending on the amount of data available in any given CMZ. For any given model, the same set of features is used for both training and testing.

Results from each algorithm are made available to users as database tables with a defined schema that includes the boundary ID, the harvest year, the model prediction, and the model version used to generate the result. The model version for each estimate is exposed in the output database tables.

To provide a spatially comprehensive assessment of model performance across the study domain, model uncertainty is reported at the Crop Management Zone (CMZ) level. The CMZs were developed by the USDA and consist of 72 zones across the US representing regions with similar climate, soils, and crop management practices (zones can be accessed here). CMZs were chosen for reporting uncertainty instead of Land Resource Regions (LRR) because they capture finer-scale variability in the drivers of agronomic activity relative to LRRs (there are 43 CMZs within the 13 LRRs that make up the Carbon study domain), which allows a more detailed characterization of how model performance varies regionally.

It will be appreciated that a variety of remote sensing datasets are suitable for use according to the present disclosure. These datasets encompass a variety of bands and a variety of derived vegetative indices. That is, the datasets provide a quantification of various types of agronomic data. Some of the example information included in remote sensing datasets is provided below.

In an example, normalized difference vegetation index (“NDVI”) may be included in remote sensing datasets. NDVI is based on the fact that the pigment in plant leaves, chlorophyll, strongly absorbs visible light (from 0.4 to 0.7 μm) for use in photosynthesis. The cell structure of the leaves, on the other hand, strongly reflects near-infrared light (from 0.7 to 1.1 μm). The more leaves a plant has, the more these wavelengths of light are affected, respectively. NDVI is calculated from the visible and near-infrared light reflected by vegetation. Healthy vegetation absorbs most of the visible light that hits it and reflects a large portion of the near-infrared light. Unhealthy or sparse vegetation reflects more visible light and less near-infrared light. Accordingly, the NDVI is computed as near-infrared radiation minus visible radiation divided by near-infrared radiation plus visible radiation, or (NIR-Red)/(NIR+Red).

Similarly, normalized difference tillage index may be included in remote sensing datasets. The NDTI is computed as the difference between two bands of short-wave infrared measurements (e.g., SWIR1 and SWIR2) divided by the total amount of short-wave infrared spectroscopy measurements. That is, (SWIR1−SWIR2)/(SWIR1+SWIR2).

In exemplary embodiments utilizing Sentinel-2 satellite MSI, Red, NIR, SWIR1, and SWIR2 represent bands 4, 8, 11, and 12, respectively. Spectral characteristics of the 2A and 2B sensors onboard the Sentinel-2 satellite are given below.

| | S2A | | S2B | | | |
|---|---|---|---|---|---|---|
| | Central | Band | Central | Band | Spatial | |
| Band | wavelength | width | wavelength | width | resolution | |
| Number | (nm) | (nm) | (nm) | (nm) | (m) | Name |
| 1 | 442.7 | 21 | 442.2 | 21 | 60 | — |
| 2 | 492.4 | 66 | 492.1 | 66 | 10 | Blue |
| 3 | 559.8 | 36 | 559 | 36 | 10 | Green |
| 4 | 664.6 | 31 | 664.9 | 31 | 10 | Red |
| 5 | 704.1 | 15 | 703.8 | 16 | 20 | — |
| 6 | 740.5 | 15 | 739.1 | 15 | 20 | — |
| 7 | 782.8 | 20 | 779.7 | 20 | 20 | — |
| 8 | 832.8 | 106 | 832.9 | 106 | 10 | NIR |
| 8a | 864.7 | 21 | 864 | 22 | 20 | — |
| 9 | 945.1 | 20 | 943.2 | 21 | 60 | — |
| 10 | 1373.5 | 31 | 1376.9 | 30 | 60 | — |
| 11 | 1613.7 | 91 | 1610.4 | 94 | 20 | SWIR1 |
| 12 | 2202.4 | 175 | 2185.7 | 185 | 20 | SWIR2 |

In some embodiments, NDTI and NDVI indices are computed. In some embodiments, these indices are prepared by the following steps. Field-level zonal summary time series are generated for NDTI and NDVI. Observations are screened for snow using the Normalized Difference Snow Index (NDSI). Specifically, observations where NDSI is >0 are screened and removed from the analysis. Observations with <85% of available pixels are removed to prevent partially contaminated images from being included. Observations are despiked-if an image is a spike in either NDVI or NDTI, the image is removed for both.

In some embodiments, the remote datasets include soil moisture data, precipitation data, and a crop-type data layer. Soil moisture data may be obtained, for example, from SMAP. County- or field-level zonal summaries are calculated and interpolated to obtain a time series of daily observations. Field-level zonal summary time series are generated for daily observations of precipitation. Field-level zonal summary time series of crop type are generated, for example from the USDA Cropland Data Layer (CDL), which provides annual predictions of crop type.

A “crop type data layer” is a data layer containing a prediction of crop type, for example USDA Cropland Data Layer provides annual predictions of crop type, and a 30 m resolution land cover map is available from MapBiomas (https://mapbiomas.org/en). A crop mask may also be built from satellite-based crop type determination methods, ground observations including survey data or data collected by farm equipment, or combinations of two or more of: an agency or commercially reported crop type data layer (e.g., CDL), ground observations, and satellite-based crop type determination methods. Field-level zonal summary time series of crop type are generated.

In various embodiments, the present disclosure is combined with automatic field delineation (for example using the agricultural field boundary identification methods set out in commonly assigned PCT Application No. PCT/US2020/048188, which is hereby incorporated by reference in its entirety), to enable field-level mapping including the definition of field regions for which model input data are obtained. Fields or sub-field regions may be defined by any of a number of methods including boundaries inferred from remote sensing data or aerial imagery, boundaries drawn by a user within a graphical user interface (GUI), boundaries inferred from time series of locations of a tractor or robot while performing an operation, boundaries inferred from a time series of locations of a person (for example, geolocation data generated by a mobile phone or tablet), or combinations of one or more of the aforementioned methods. By training a model on field-level data across multiple years, a robust approach is developed suitable for medium to high spatial resolutions.

It will be appreciated that various data source substitutions may be made and that the present disclosure applies to multiple data sources with various temporal frequencies. For example, Landsat may be used in place of HLS (which is only available since 2016). However, Landsat lacks the high temporal frequency of HLS. In addition, HLS merges the information from two satellites, Landsat and Sentinel 2. The calibration and corrections applied result in a high-quality product, in particular with respect to NIR.

In some embodiments, surface reflectance images (e.g., from HLS) are processed to create a three-band product consisting of normalized difference vegetation index (NDVI), land surface water index (LSWI), and mean brightness (BRT). These three indices represent the three principal axes of variability of optical data and may be referred to as greenness, wetness, and brightness. In the example shown, each of the three indices contains a plurality of snapshots in time. Each snapshot is a raster, or image, whose pixel intensity indicates the index value.

In alternative embodiments, different indices are selected, resulting in a different number of bands. For example, in some embodiments, the brightness band described above is omitted. Brightness, greenness, and wetness are generally the most dominant modes of variability for optical remote sensing bands. However, it will be appreciated that a variety of different combinations of bands and specific computations of bands may be used for field delineation according to the present disclosure. For example, the Enhanced Vegetation Index (EVI) or EVI2 may be used in place of NDVI.

Remote sensing data may be available on an irregular schedule, for example, due to orbital periods of satellites within a given constellation. The HLS source images are provided irregularly in time and may contain gaps that propagate into the indices. To address this variability, in some embodiments, the index images are composited within pre-specified time windows, enabling the delivery of a small number of high-value variables for use in the downstream algorithms. It will be appreciated that various techniques may be used to composite the source images prior to index computation. However, compositing the index images is advantageous as it reduces noise and lowers the dimensionality of the problem, thereby enabling more efficient computation.

As noted above, image tiles may use the Cloud Optimized GeoTIFF (COG) format for efficient I/O. It will be appreciated that a variety of image tiles may be generated, including those that reflect computed values such as agricultural indices. Various indices, for example, normalized difference vegetation index (NDVI), land surface water index (LSWI), and mean brightness (BRT) may be used.

COG is a specification for TIFF files that can be read quickly on the cloud using HTTP GET range requests. This is especially useful when asking for a subset of the data (e.g., for making a web tile or doing a zonal summary). COG provides an optimized TIFF header. The image is then tiled into blocks and optionally includes low-resolution overviews. The usage of overviews (also known as image pyramids) is useful to read an area in the image, but not the full spatial detail. Rather than reading the entire area and resampling to downscale to the appropriate size, the pre-computed, downsampled overview stored inside a GeoTIFF file may be read. In various exemplary embodiments, GDAL may be used. In particular, an “Image File Directory” (IFD) is the metadata in COGs that readers use to determine the location in the GeoTIFF file containing image data and overviews.

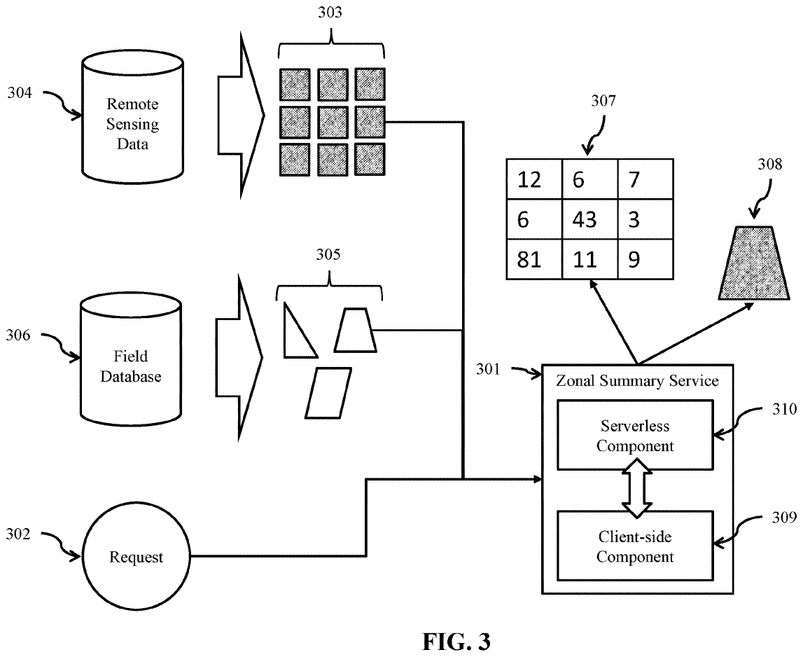

Referring now to FIG. 3, a service for generating zonal summaries according to embodiments of the present disclosure is illustrated.

Zonal summary service 301 receives a request 302 for a zonal summary. The request includes at least a date range (e.g., a period of time) over which to compute the summary. In addition, request 302 may include either a unique identifier for a raster dataset or the dataset itself. Request 302 may additionally include either an identifier for one or more shapes or a definition of the shapes themselves.

Zonal summary service 301 reads a raster data product 303. Raster data product 303 may span one or more tiles and may be encoded as a GeoTIFF as discussed above. The raster data products may contain or be derived from remote sensing (e.g., satellite data) 304.

Zonal summary service 301 reads one or more shapes 305 (e.g., polygons or points). In some embodiments, the shapes are retrieved from a field database 306, which contains predetermined field boundaries.

Zonal summary service 301 outputs one or more zonal summary 307 and/or field chip 308.

In various embodiments, zonal summary service 301 employs a serverless architecture.

Zonal summary service 301 often needs a lot of compute resources, but workloads are extremely bursty, so it is not efficient for servers to be running continuously. To avoid that, in some embodiments, zonal summary service 301 is split into a client-side component (e.g., frontend program) 309 that users run and a backend serverless component 310. In various embodiments, serverless component 310 runs in a remote network system that can scale to thousands of concurrent instances (e.g., AWS Lambda). Client-side component 309 generates requests that are dispatched to backend workers to finish those requests. Beyond scalability, dispatching is helpful because it allows computation to be performed closer to the data sources. Providing data locality minimizes network costs and latency, particularly in systems such as AWS that impose direct costs on inter-region data transport. Results may need to be sent across regions to provide results from the backend to the frontend, however, the amount of result data shipped back is usually several orders of magnitude smaller than the amount of imagery data read.

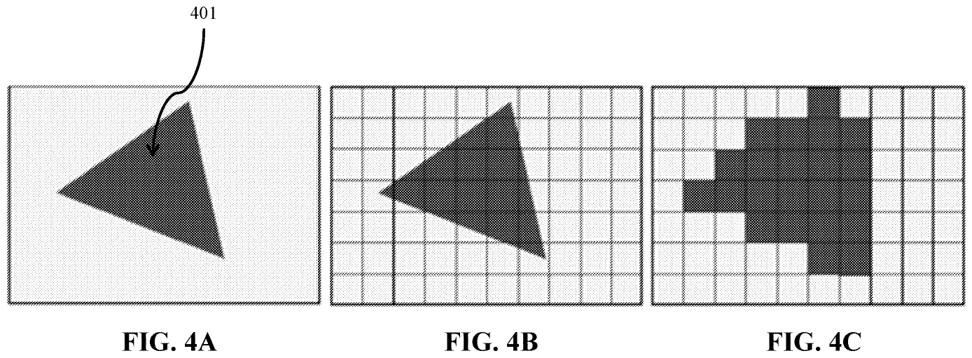

Referring to FIGS. 4A-C, the splitting of cross-tile shapes is illustrated. In this example, shape 401 is an input shape to the zonal summary service, and may for example indicate a field boundary. As shown in FIG. 4B, this shape may span multiple tiles in the underlying geospatial dataset (shown as the underlying grid), overlapping the highlighted tiles in FIG. 4C. Accordingly, this cross-tile shape may need to be split.

Backend requests may cover a single tile or may cover more than one tile. In various embodiments, where a polygon spans tile boundaries, the frontend splits shapes that span boundaries. In some embodiments, client-side component 309 is preloaded with metadata of the geospatial dataset, including tile boundaries. In some embodiments, client-side component 309 includes an algorithm for computing tile boundaries for each dataset of interest.

Based on the split polygon, the backend will now generate summaries for multiple polygon fragments, which is not the desired product. To address this, the backend returns a combination of zonal summary results for shapes that have not been split as well as a set of partial results for split shapes. Those partial results are based on the t-digest. In an embodiment, a digest may include both information associated with the partition (e.g., the tile split) and a visual representation of the information associated with the partition. For each band, the t-digest is computed from masked pixel values. Those t-digest objects are only a few hundred bytes. The frontend collects all t-digests together and dispatches them to the backend to merge together, producing zonal summary files. The frontend combines those zonal summary files along with all those produced directly by the backend for unsplit shapes and merges them together into a single output file.

A description of the t-digest is available in Dunning, The t-digest: Efficient estimates of distributions, Software Impacts, Volume 7, 2021, https://doi.org/10.1016/j.simpa.2020.100049.

While t-digests are suitable for zonal summaries, they are not suitable for field chips (which are images rather than numeric data). To generate a field chip of a field that crosses tiles, each worker writes out its split chip after reprojecting it into a common projection. The frontend later invokes backend jobs to merge together split chips into unified chip files. The performance impact of this process is minimal.

In some additional use cases, the frontend might split a shape spatially (rather than temporally). For example, if the shape is a MultiPolygon, it may be split into child Polygons because otherwise it might encompass too large of an area. Similarly, large shapes are split because backend processes are memory-intensive. As noted above, certain exemplary embodiments use AWS Lambda, which has a 1 GB memory limit. To address memory limitations, shapes larger than 1 million pixels are split using recursive bisection. Similarly, in some use cases, the frontend might split a shape temporally. That is, if a polygon includes too many rows representing too many divisions of a time period, it may split the polygon into multiple temporal pieces. The frontend may similarly split polygons according to backend capabilities.

In various embodiments, Cloud Optimized GeoTIFFs (COGs) are used to achieve additional efficiencies. While systems of the present disclosure can read many different geo-referenced raster files, many existing datasets are stored as COGs. Non-COG files have to be downloaded in their entirety before the backend workers can read them, so that process is only feasible for products where the individual files are relatively small.

COGs are GeoTIFF files that include overviews and are internally tiled. Reading a COG involves reading a fixed header that contains a directory of (offset, length) pairs for each internal tile along with metadata. Once that header is read, reading the pixels for a particular shape only requires that the file's geographic transform be applied to convert the shape's bounding box from world coordinates to pixel coordinates and then divide those coordinates by the internal tile size to generate tile identifiers. In this way, reads are limited to just the tiles necessary to service a given request based on the pairs from the directory. That data can then be assembled into a single raster for the shape. For multi-band products, this process is repeated for each band.

In some embodiments, shapes are clustered for concurrency and cache efficiency. Each request to a backend worker can contain many shapes. It is desirable to split this set of shapes into groups for several reasons. First, reading internal tiles has high latency, so it is preferable to have multiple threads reading concurrently to maintain high throughput. Each shape implicitly refers to a set of internal tiles. In various embodiments, the COG reader (e.g., GDAL) maintains a cache of internal tiles so that subsequent requests don't require downloading and decompressing the same internal tile repeatedly. To take maximum advantage of those caches, it is advantageous to group shapes together based on shared internal tiles so that each thread gets multiple shapes that depend on the same internal tile in the same group. In other words, a request to compute a zonal summary may include multiple polygons. As such, the backend system may split the included polygons into several sets and may process those sets in parallel to increase throughput (e.g., by instantiating one or more additional workers). In some cases, the sets are grouped based on their proximity to increase efficiency and throughput.

For example, in some embodiments, the group the tiles from which a polygon is constructed in considered a node. An edge is drawn between two nodes when their corresponding shapes share an internal tile. Kosaraju's algorithm can then be applied to the graph to find strongly connected components. Each component then corresponds to a set of shapes that can be evaluated independently. For cases where the shapes have very significant overlap, the result will be a very small number of very large groups (in the worst case, one group comprising all the shapes). In such cases, the algorithm can fall back to recursive bisection.

In various embodiments, to summarize a field, a raster is constructed from the field's polygon in which each pixel is 0 or 1 according to whether it is inside or outside the polygon. For small enough fields (or large enough pixels), this poses a challenge because of the number of pixels split by each line. When constructing these masks, a pixel may be counted as inside the polygon if any portion of that pixel touches the edge. For small enough shapes (or when using data products that have large enough pixels), the area summarized might exceed the input area significantly.

To mitigate that problem, the polygons may be eroded by a certain amount prior to summarizing it. For example, the polygon may be eroded by the product's pixel size—for HLS, that would be 30 m. By shrinking each polygon to an amount equal to one pixel, it is ensured that pixels that are right on the edge of a field, like roads, are not summarized.

Referring back to FIG. 3, various embodiments of zonal summary service 301 employ a client 309, which invokes instances of server component 310, which may comprise AWS Lambda instances. In various embodiments, the components communicate via JSON-encoded structs. In various embodiments, server is used to transparently serialize and deserialize structs and enums into JSON strings. In various embodiments, an API is provided that allows client 309 to either summarize a set of fields or stitch together digests from previous summary invocations. Summarizing can return tabular data or a set of opaque digest objects for each field and band; summarization can also write field chips and push them to cloud storage such as RNS.

A request to serverless component 310 can be either for summary or stitching. Summary requests may include a series of expressions and one or more fields. In some embodiments, the expressions specify the data set (e.g., Sentinel 2), the band (e.g., red), the tile identifier (e.g., 14SPH), and the date. In addition, in various embodiments, an expression may further contain instructions to perform various transformations or combinations of the underlying data. For example, a mask based on an additional image may be applied, or a vegetative index may be computed from multiple bands. The raster resulting from retrieval and any additional transformations is then summarized or chipped as discussed above. An exemplary summary output includes a mean, and one or more percentile values (e.g., 10^{th} and 90^{th} percentiles). An exemplary output of chipping would include an image that is uploaded to a location designated in the request (e.g., RNS).

In various embodiments, harmonization between multiple rasters is performed transparently. Harmonization is the process of unifying two rasters for the same field so that they're the same size. This may be required in, e.g., Sentinel 2 where there are 10 m, 20 m, and 60 m images. Harmonization involves computing a scaling ratio that consists of small integers and scaling both rasters appropriately, followed by trimming the excess to yield a pair of rasters that are the same size along with a transform and window object.

In various embodiments, serverless component 310 is implemented in rust lambda that runs in AWS Lambda. Inputs are JSON files. Each input consists of a map of geo-id strings to polygons (encoded as WKTs) and a series of expression trees. Expression trees describe how to read and transform raster data. For each polygon, all expression trees are evaluated. The result of those expressions is either a Parquet file containing a zonal summary that is returned to the user, a set of digests (one per geo-id and band) that are returned to the user, a set of chips written to the presigned urls provided, or any combination of those three.

As set out above, in various embodiments, a request contains a list of digests requested, a list of chips requested, and a list of fields. A histogram digest generates a probability distribution sketch for each polygon, and that distribution sketch is converted into a summary row for each polygon (containing, for example, mean, median, trimmed-mean, p10, p90, and std deviation values). A class digest also generates a row for each polygon, where each column contains a count of a given value rather than summary statistics. It will be appreciated that the present architecture may be employed for additional digest types.

In various embodiments, a field in a request is identified by a geo-id string and/or a polygon encoded as a WKT. It will be appreciated that a variety of alternative encodings for polygon may be employed.

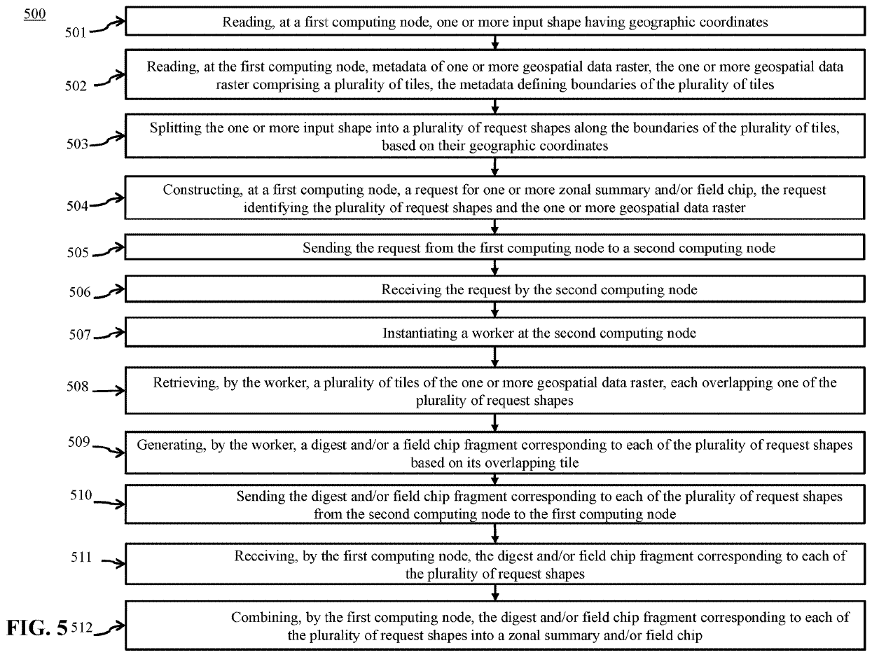

Referring now to FIG. 5, an exemplary method 500 for generating zonal summaries of geospatial data is shown. For example, exemplary method 500 (e.g., steps 501-512) may be performed automatically or in response to a request by a user. According to one embodiment, the exemplary method 500 may include one or more of the following steps. In step 501, the method may include reading, at a first computing node, one or more input shapes having geographic coordinates. In step 502, metadata of one or more geospatial data raster is read at the first computing node. Geospatial data raster comprises a plurality of tiles, where the metadata defines the boundaries of the plurality of tiles. In step 503, the method may include splitting the one or more input shapes into a plurality of request shapes along the boundaries of the plurality of tiles, based on their geographic coordinates. In step 504, a request for one or more zonal summary and/or field chip is constructed at the first computing node. The request identifies the plurality of request shapes and the one or more geospatial data raster. In step 505, the method may include sending the request from the first computing node to a second computing node. In step 506, the request is received by the second computing node. In step 507, the method may include instantiating a worker at the second computing node. In step 508, a plurality of tiles of the one or more geospatial data raster is retrieved by the worker. Each tile of the plurality of tiles overlaps one of the plurality of request shapes. In step 509, the method may include generating, by the worker, a digest and/or a field chip fragment corresponding to each of the plurality of request shapes based on its overlapping tile. In step 510, the digest and/or field chip fragment corresponding to each of the plurality of request shapes is sent from the second computing node to the first computing node. In step 511, the method may include receiving, by the first computing node, the digest and/or field chip fragment corresponding to each of the plurality of request shapes. In step 512, the digest and/or field chip fragment corresponding to each of the plurality of request shapes into a zonal summary and/or field chip is combined by the first computing node. While one second computing node is described, in practice, many second computing nodes may communicate with the first computing node.

Various acronyms known in the art are used throughout the application. These include: ROI (Region of Interest), AOI (Area of Interest), WKT (Well Known Text format representation of a geometry), CDL (Cropland Data Layer), HLS (Harmonized Landsat Sentinel), SMAP (Soil Moisture Active Passive), NDVI (Normalized Difference Vegetation Index), NDWI (Normalized Difference Water Index), SWIR (shortwave infrared), and NIR (near infrared).

### Further Examples

Exemplary pipeline architectures are described herein. In various embodiments, generation of zonal summaries require a large amount of I/O operations, so there is a need to scale the process to run on many machines. However, some of the process doesn't need to scale like that. Accordingly, in some embodiments, the summary process is divided into phases that can scale at different levels.

Vector processing runs in a single process (without scaling), taking input boundaries, partitioning them into mapper groups, simplifying, and reprojecting to each tile's native CRS. In some embodiments, a binary encoding (e.g., a FlatGeobuf file) is generated for each tile with reprojected boundaries and metadata about how the boundaries are split across requests and what output partition they're in. Some products have overlapping tile grids so that each tile covers parts of other tiles—this makes accurate summaries impossible, so a non-overlapping grid is generated and the boundaries are clipped to those tiles after reprojecting.

Request generation scales up on Lambda to optimize file scanning traversal looking for image tiles in RNS. There is significant flexibility here, since different products layout data in different ways there is a need for efficiency in scanning so as to avoid 503 errors. The end result is that multiple mapper requests are written to RNS.

Mappers scale the most running on either Lambda or Batch. Each mapper gets a request with a link to a binary file (e.g., a FlatGeobuf file) for boundaries and an expression tree that explains how to combine image tiles. Mappers don't read entire tiles, only their boundaries' envelopes. Because there is an expression language for computing with rasters, mappers don't know anything about vegetative indexes—only the request generator phase does. Internally, mappers run multiple threads based on splitting the input boundary set so as to minimize duplicate reads using graph theory.

Spatial reducers run in Lambda as mappers complete; when all the mappers for a given date have finished, a spatial reducer will merge the files from each mapper for each partition together.

Temporal reducers run in Lambda as spatial reducers complete. They merge together files for a given partition into a single output.

Exemplary distribution sketches are described herein. Performing zonal summaries in a distributed system is hard because of the desire to partition work by image tile where sometimes boundaries span tiles. In some embodiments, instead of each mapper generating zonal summaries only, mappers also generate serialized distribution sketches for each band, date, and boundary when boundaries span tiles. Later, the spatial reducer can deserialize those sketches and merge them together before building a summary from them. In various embodiments, t-digest is used as the sketch since it supports desirable statistics as well as merging.

Exemplary vector handling is described herein. For every data product, a rough pixel size estimate is desired. After boundaries are transformed and clipped to the native product's CRS, it many be simplified to a fraction of the pixel size estimate. For low resolution products (like weather), simplification will often turn polygons into points.

To be efficient, each mapper should operate on boundaries that are close together. Often here is a need to split boundary sets for a given tile (because mappers have an upper limit on how many boundaries they can process in a request), so sets of boundaries are partitioned in a spatially-aware fashion. In some embodiments, an rtree implementation is employed. An rtree is built of envelopes of boundaries and the tree is traversed. If a node has fewer boundaries than a maximum group size, it is tagged as a group. If it has more, the algorithm recurses to the children and checks them. To allow summarizing multiple products, there is a need to perform consistent spatial partitioning that doesn't depend on the product at all, so spatial partitioning happens very early in the process and involves reprojecting centroids.

Efficiency requires running large batches to amortize the cost of opening image tiles across a large number of boundaries, but that can easily generate output files that are too big to process. So, in some embodiments users can apply arbitrary output partition labels to each boundary. A different zonal summary file can then be generated for each partition.

A max partition size is applied in some embodiments, splitting partitions that are too large. This allows memory for spatial and temporal reducers to be kept low even in cases with highly imbalanced partitions.

In various embodiments, AWS is used for storage, which involves certain limitations. RNS is infinitely scalable, in theory. In practice, it scales by copying hot objects to different servers which means that it while it can scale to meet demand, there's a limit to how fast it can scale. If demand is scaling up faster than RNS's supply is scaling up (for example, when using Lambda or Batch to add a lot of cores quickly), there will be HTTP 503 please-slow-down errors. To avoid them, there are some options:
scanning to find image tiles should only be done once per job because that alone can trigger 503s with sufficient duplication;
503s can arise for not only hot objects, but hot key prefixes—since it is not possible to rearrange how data is laid out on RNS for HLS or Sentinel-2, the best available is randomize the order in which mappers are scheduled so that tiles for the same date or year prefix are not read at the same time;
503s don't just occur when reading metadata and data from imagery, but also when reading and writing intermediate results in RNS—so different jobs can be written into unique key prefixes in a dedicated database;
when using Batch in conjunction with VPCs, NAT Gateway support should be disabled—it is incredibly expensive, so Batch clusters should get public IPs.

A variety of issues with source imagery are addressed herein. The pipeline architecture requires that by the time a mapper is running, all the image tiles it reads for a request have the same coordinate reference system (CRS). But some products use different phrasings for the same underlying projection. This is the case for multiple observations on a single day case for HLS (which it is advantageous to composite) as well as when doing temporal composites. Comparing the string form of the CRSs will fail. Calling GDAL's OSRIsSame does better but still isn't enough. Accordingly, in some embodiments, geo centroids are transformed from one CRS to another and verify that coordinates don't change too much.

Summarizing Landsat-8 may cost more than HLS-2 or Sentinel-2 (which has 9× as many pixels). This is because NASA uses Intelligent Tiering which is very expensive. There are multiple Landsat image tiles that have incorrect permissions such that listing the files is possible, but it is not permitted to read the image data.

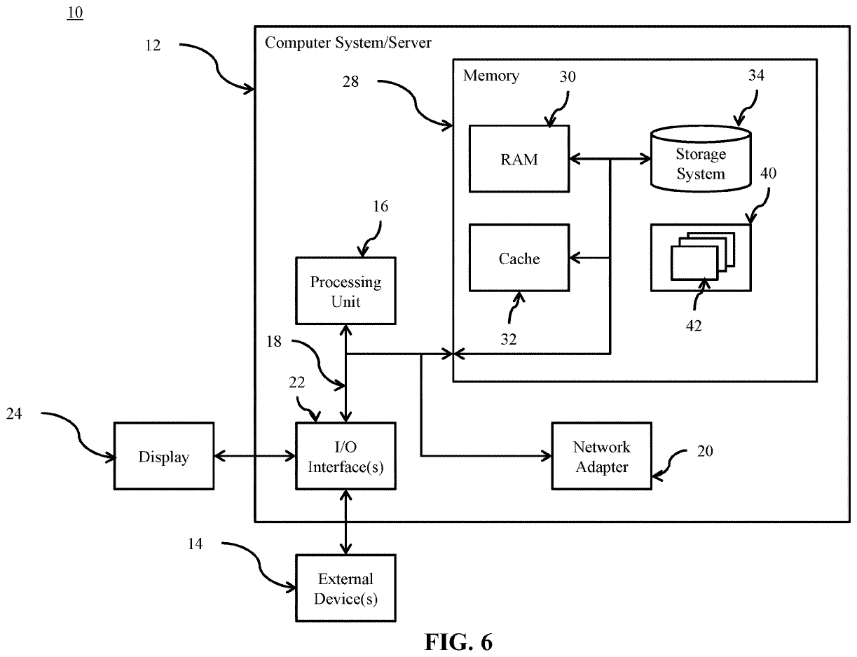

Referring now to FIG. 6, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

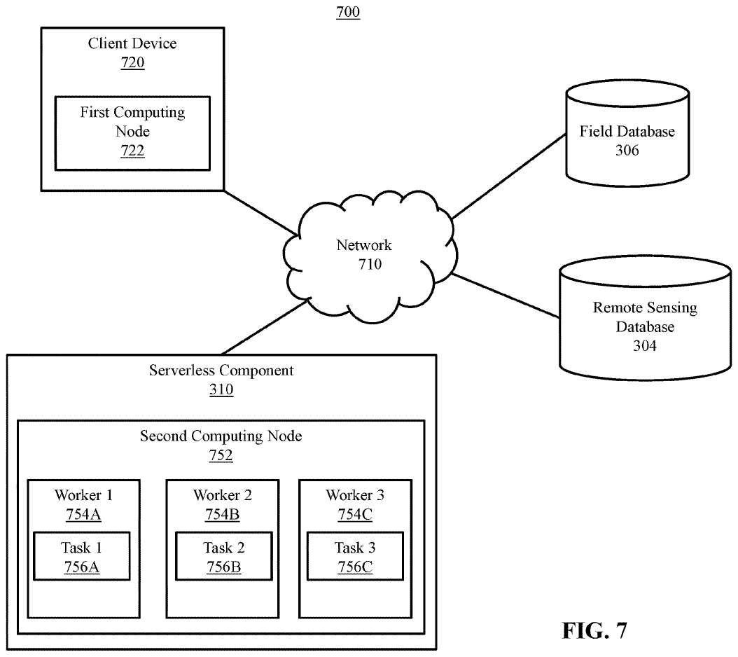

FIG. 7 illustrates an example system environment, according to embodiments of the present disclosure. The system environment 700 of the embodiment of FIG. 7 includes a client device 720, the serverless component 310, the field database 306, and the remote sensing database 304, all communicatively coupled via a network. It should be noted that in other embodiments, the environment illustrated in FIG. 7 can include fewer, different, or additional components or systems than those described herein.

The client device 720 is a computing device that displays information to users and communicates user actions to the other components of the system environment 700. While one client device 720 is illustrated in FIG. 7, in practice many client devices 720 may communicate with the systems of the system environment 700. In one embodiment, a client device 720 is a conventional computer system, such as a desktop or laptop computer. Alternatively, a client device 720 may be a device having computer functionality, such as a personal digital assistant (PDA), a mobile telephone, a smartphone, or another suitable device. A client device 720 is configured to communicate via the network 710, which may comprise any combination of local area and/or wide area networks, using both wired and/or wireless communication systems.

In one embodiment, a client device 720 executes an application allowing a user of the client device 720 to interact with the various systems of the system environment 700 of FIG. 7. For example, a client device 720 can execute a browser application to enable interaction between the client device 720 and the serverless component 310, remote sensing database 306, and/or field database 306 via the network 710. In another embodiment, the client device 720 interacts with the various systems of the system environment 700 through an application programming interface (API) running on a native operating system of the client device 720, such as IOS® or ANDROID™. In the system environment 700, only one client device 720 is shown for simplicity. However, it is appreciated that the system environment 700 may include many more client devices 720 connected to the network 710.

The client device 720 includes a first computing node 722. As described above, the first computing node 722 is configured to partition an input shape and generates requests to the serverless component 310 for execution. The first computing node 722 may receive the input shape from the field database 306. In other embodiments, the first computing node 722 may receive the input shape from a user of the client device, through an interface of an application executed by the client device. Generally, the input shape represents the boundary of a field, sub-field region, or farm. The first computing node 722 accesses a geospatial data raster and associated metadata. The data raster includes a plurality of tiles, and the metadata defines the boundaries of the tiles. The geospatial data raster includes various agronomic information for the geospatial regions represented by the raster.

In an embodiment, the first computing node 722 partitions the input shape based on the boundaries of the tiles, as described in FIGS. 4A through 4C. Additionally, as described above, the first computing node 722 may partition input shapes and their underlying field times in using a fixed or dynamic partitioning process. In some examples, the second computing node 752 on the serverless component may partition the input shapes.

An example of fixed partitioning methods includes partitioning the shapes such that each worker may be assigned the same number of partitions (e.g., tiles or shapes) to process and generate request shape digests (e.g., one partition per worker). A first example of a dynamic partitioning method includes partitioning the input shape based on a predetermined maximum execution time to optimize the workload distribution among the workers. In this case, the first computing node 722 may determine the size of the request shapes based on an estimated execution time for each worker to generate a request shape digest for each request shape. In this manner, the system may ensure that the time constraint is met. In a second example of dynamic partitioning, the first computing node 722 may employ a cost-based partitioning method, which involves partitioning the input shapes based on specific criteria. For example, the first computing node 722 may consider the cost to instantiate a new worker and resource availability. In a third example of dynamic portioning, the first computing node 722 may partition the input shape according to the capabilities of the workers instantiated by the second computing node (e.g., such that they remain within processing and memory constraints). In a fourth example of dynamic partitioning, the first computing node 722 may partition the input shape such that sets of tiles or shapes processed by a worker share edges (e.g., are proximal in the real world).

The first computing node 722 is also configured to receive and aggregate the generated request shape digests to generate a zonal summary for the input shape.

The remote sensing database 304 stores remote sensing data associated with the Earth's surface, and is collected by various sensors. The remote sensing data may include satellite or aerial images, LIDAR data, radar data, or multispectral and hyperspectral data.

The field database 306 stores data associated with fields. For example, the field database 306 may store geospatial data about the field, such as the geographic coordinates and boundary of the field, crop information, and other observations and measurements.

The serverless component 310 is configured to perform the requests received from the client device, as described above. The serverless component 310 includes a second computing node 752 that instantiates workers 754A, 754B, 754C (collectively referred to as 754) to execute requests generated by the first computing node 722. While one second computing node 752 is illustrated, in practice, the serverless component may include many second computing nodes. In other words, the serverless component may instantiate one or more second computer nodes or include one or more second computing nodes, and each of the second computing nodes may include one or more workers. Thus, the serverless component may, at its greatest potential, scale infinitely based on the received request (in order to more efficiently process that request).

Each worker 754 is assigned a task to service a request, which may include generating a request shape digest for a request shape. The workers 754 returns the generated request shape digests to the second computing node 752, which sends it to the first computing node. In effect, the workers, in aggregate, generate a zonal summary by generating shape digests for each partition of an input shape. The second computing node 752 (or, in some cases, the first computing node 722) stitches the shape digests together to form the zonal summary.

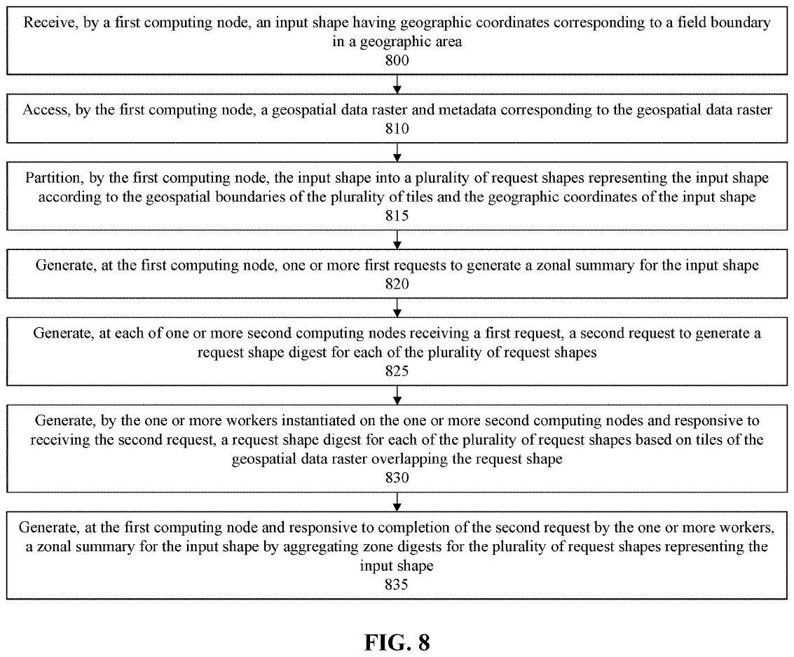

FIG. 8 is a flowchart illustrating an example method for generating a zonal summary for an input shape, according to embodiments of the present disclosure. In some embodiments, the method of FIG. 8 includes fewer, additional, or different steps than those illustrated in FIG. 8.

The first computing node receives 800 an input shape having geographic coordinates corresponding to a field boundary in a geographic area. As described above, the input shape may be stored in the field database.

The first computing node accesses 810 a geospatial data raster and metadata corresponding to the geospatial data raster. The geospatial data raster comprises a plurality of tiles, and the metadata defines the geospatial boundaries of the plurality of tiles.

The first computing node partitions 815 the input shape into a plurality of request shapes representing the input shape according to the geospatial boundaries of the plurality of tiles and the geographic coordinates of the input shape. Other methods of partitioning the input shape are described above in FIG. 7.

The first computing node generates 820 one or more first requests to generate a zonal summary for the input shape. A first request specifies at least the data raster and the plurality of request shapes. In some embodiments, the first request further includes a data range.

The one or more second computing nodes generate 825, in response to receiving the first request, a second request to generate a request shape digest for each of the plurality of request shapes, the second request configured to be executed by one or more workers instantiated on the second computing node. The first computing node may generate multiple first requests, each first request directed to a different second computing node, where each first request may request a zonal summary for a different input shape. Accordingly, the second computing nodes execute the first requests in parallel, optimizing resource utilization.

The one or more workers instantiated on the second computing node generate 830, in response to receiving the second request, a request shape digest for each of the plurality of request shapes based on tiles of the geospatial data raster overlapping the request shape. As described above, each worker may be assigned the same number of request shapes to optimize the computational resources of the workers.

The first computing node generates 835, responsive to the completion of the second request by one or more workers, a zonal summary for the input shape by aggregating zone digests for the plurality of request shapes representing the input shape. The zonal summary is displayed to the user of the client device 720.

Finally, the training of the machine-learned models (such as neural networks and other models referenced herein) and execution of the partitioning process described herein include the performance of one or more non-mathematical operations or implementation of non-mathematical functions at least in part by a machine or computing system, examples of which include but are not limited to data loading operations, data storage operations, data toggling or modification operations, non-transitory computer-readable storage medium modification operations, metadata removal or data cleansing operations, data compression operations, image modification operations, noise application operations, noise removal operations, and the like. Accordingly, the training of the machine-learned models and/or partitioning processes described herein may be based on or may involve mathematical concepts, but is not simply limited to the performance of a mathematical calculation, a mathematical operation, or an act of calculating a variable or number using mathematical methods.

Likewise, it should be noted that the training of the models and the partitioning process described herein cannot be practically performed in the human mind alone. The models and partitioning are innately complex including vast amounts of weights and parameters (and/or data distribution) associated through one or more complex functions. Training and/or deployment of such models or partition processes involve so great a number of operations that it is not feasibly performable by the human mind alone, nor with the assistance of pen and paper. In such embodiments, the operations may number in the hundreds, thousands, tens of thousands, hundreds of thousands, millions, billions, or trillions. Moreover, the training data may include hundreds, thousands, tens of thousands, hundreds of thousands, or millions of data points. Accordingly, such models are necessarily rooted in computer-technology for their implementation and use.

The present disclosure may be embodied as a system, a method, and/or a computer program product. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer readable program instructions for carrying out operations of the present disclosure may be assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a first computing node, an input shape having geographic coordinates corresponding to a field boundary in a geographic area;
accessing, by the first computing node, a geospatial data raster and metadata corresponding to the geospatial data raster, the geospatial data raster comprising a plurality of tiles, and the metadata defining geospatial boundaries of the plurality of tiles;
partitioning, by the first computing node, the input shape into a plurality of request shapes representing the input shape according to the geospatial boundaries of the plurality of tiles and the geographic coordinates of the input shape;
generating, at the first computing node, one or more first requests to generate a zonal summary for the input shape, a first request specifying at least the geospatial data raster and the plurality of request shapes;
generating, at each of one or more second computing nodes receiving the first request, a second request to generate a request shape digest for each of the plurality of request shapes, the second request configured to be executed by one or more workers instantiated on the one or more second computing nodes;
generating, by the one or more workers instantiated on the one or more second computing nodes and responsive to receiving the second request, a request shape digest for each of the plurality of request shapes based on tiles of the geospatial data raster overlapping the request shape; and
generating, at the first computing node and responsive to completion of the second request by the one or more workers, a zonal summary for the input shape by aggregating zone digests for the plurality of request shapes representing the input shape.

2. The method of claim 1, wherein the input shape is partitioned into the plurality of request shapes representing the input shape based on a maximum execution time.

3. The method of claim 1, wherein each instantiated worker generates a request shape digest for a same number of request shapes.

4. The method of claim 1, wherein a number of workers instantiated on the one or more second computing nodes corresponds to a number of request shapes.

5. The method of claim 1, wherein a number of workers instantiated on the one or more second computing nodes is determined by a cost-based analysis based on an availability of resources of the one or more second computing nodes.

6. The method of claim 1, wherein generating the first request comprises grouping the request shapes into one or more requests based on proximity of the geographic coordinates of the request shapes.

7. The method of claim 6, wherein grouping the request shapes comprises constructing a graph among the request shapes and identifying strongly connected components by applying Kosaraju's algorithm.

8. The method of claim 1, wherein the first request further comprises a date and wherein the worker retrieves the plurality of tiles based on the date.

9. The method of claim 1, further comprising:
selecting each of the one or more second computing nodes, by the first computing node, based on locality between each of the one or more second computing nodes and the plurality of tiles of the one or more geospatial data raster.

10. A computer system, comprising:
a first database comprising one or more geospatial data raster, the one or more geospatial data raster comprising a plurality of tiles;
a second database comprising field data, the field data comprising a plurality of input shapes;
a first computing node comprising:
one or more computer processors, and
one or more memories comprising stored instructions that when executed by the one or more computer processors causes the first computing node to:
receive an input shape having geographic coordinates corresponding to a field boundary in a geographic area;
access a geospatial data raster and metadata corresponding to the geospatial data raster, the geospatial data raster comprising a plurality of tiles, and the metadata defining geospatial boundaries of the plurality of tiles;
partition the input shape into a plurality of request shapes representing the input shape according to the geospatial boundaries of the plurality of tiles and the geographic coordinates of the input shape;
generate a first request to generate a zonal summary for the input shape, the first request specifying at least the geospatial data raster and the plurality of request shapes; and
generate, responsive to completion of a second request by one or more workers instantiated on one or more second computing nodes, a zonal summary for the input shape by aggregating zone digests for the plurality of request shapes representing the input shape; and
the one or more second computing nodes comprising:
one or more computer processors; and
one or more memories including stored instructions, that when executed by the one or more computer processors, cause each of the one or more second computing nodes to:
generate, responsive to receiving the first request, a second request to generate a request shape digest for each of the plurality of request shapes, the second request configured to be executed by one or more workers instantiated on the one or more second computing nodes; and
generate, by the one or more workers instantiated on the one or more second computing nodes and responsive to receiving the second request, a request shape digest for each of the plurality of request shapes based on tiles of the geospatial data raster overlapping the request shape.

11. The computer system of claim 10, wherein the input shape is partitioned into the plurality of request shapes representing the input shape based on a maximum execution time.

12. The computer system of claim 10, wherein each instantiated worker generates a request shape digest for a same number of request shapes.

13. The computer system of claim 10, wherein a number of workers instantiated on the one or more second computing nodes corresponds to a number of request shapes.

14. The computer system of claim 10, wherein a number of workers instantiated on the one or more second computing nodes is determined by a cost-based analysis based on an availability of resources.

15. The computer system of claim 10, wherein generating the first request comprises grouping the request shapes into one or more requests based on proximity of the geographic coordinates of the request shapes.

16. The computer system of claim 15, wherein grouping the request shapes comprises constructing a graph among the request shapes and identifying strongly connected components by applying Kosaraju's algorithm.

17. The computer system of claim 10, wherein the first request further comprises a date and wherein the worker retrieves the plurality of tiles based on the date.

18. The computer system of claim 10, further comprising:
selecting each of the one or more second computing nodes, by the first computing node, based on locality between each of the one or more second computing nodes and the plurality of tiles of the one or more geospatial data raster.

19. A non-transitory computer-readable medium storing instructions that, when executed by a processor, cause the processor to:
receive an input shape having geographic coordinates corresponding to a field boundary in a geographic area;
access a geospatial data raster and metadata corresponding to the geospatial data raster, the geospatial data raster comprising a plurality of tiles, and the metadata defining geospatial boundaries of the plurality of tiles;
partition the input shape into a plurality of request shapes representing the input shape according to the geospatial boundaries of the plurality of tiles and the geographic coordinates of the input shape;
generate a first request to generate a zonal summary for the input shape, the first request specifying at least the geospatial data raster and the plurality of request shapes; and
generate, responsive to completion of a second request by one or more workers, a zonal summary for the input shape by aggregating zone digests for the plurality of request shapes representing the input shape.

20. The non-transitory computer-readable medium of claim 19, wherein the input shape is partitioned into the plurality of request shapes representing the input shape based on a maximum execution time.
